(19) United States
(12) Patent Application Publication
(10) Pub. No.: US 2025/0338828 A1
(43) Pub. Date: Nov. 6, 2025

(54) RETRACTABLE LEASH DEVICE FOR UNCOILING AND COILING AN ANIMAL LEASH

(71) Applicant: Diligent Verwaltung GmbH, Cologne (DE)

(72) Inventors: Christoph Traxler, Künzell (DE); Norbert Wülbeck, Brilon (DE)

(73) Assignee: Diligent Verwaltung GmbH, Cologne (DE)

(21) Appl. No.: 19/199,759

(22) Filed: May 6, 2025

(30) Foreign Application Priority Data
May 6, 2024 (EP) 24 174 342.6
Apr. 28, 2025 (EP) 25 172 920.8

(51) Int. Cl. A01K 27/00

(52) U.S. Cl. CPC A01K 27/004

(57) ABSTRACT

The disclosure relates to a retractable leash device for uncoiling and coiling an animal leash. The retractable leash device including a housing, a spool body and a return spring which pushes the spool body back into a coiling position or holds it there. A braking device is provided, which has a brake element designed to brake the spool body. The brake element is movable against the force of a return element from a rest position, in which the spool body can rotate freely, into a braking position, in which the brake element brakes rotation of the spool body. A remaining length detection device designed to determine a predetermined remaining length of the animal leash is provided, and an automatic braking device coupled to the remaining length detection device is provided, which, when the predetermined remaining length of the animal leash is reached, urges the braking element in the direction of an automatic braking position and brakes the coil body with an automatic braking force.

The invention relates to a retractable leash device for uncoiling and coiling an animal leash, wherein the retractable leash device comprises a housing, a spool body rotatably mounted on the housing, and a return spring which pushes the spool body into a coiling position in which the animal leash is arranged coiled on the spool body, wherein the spool body is rotatable out of the coiling position against a return force of the return spring for uncoiling the coiled animal leash.

Such a retractable leash device is also commonly referred to as a flex leash or a self-retracting animal leash, wherein known flex leashes usually consist of an animal leash or a strap which is coiled onto a spool body on a housing-like handle. A snap hook is arranged at the end of the animal leash or strap, to which a collar of the animal to be led is attached. The spool body has a spiral spring which automatically coils the animal leash when the animal runs back to its owner or to the leash holder.

If the animal runs far enough away from the leash holder and thus from the retractable leash device so that the animal leash is completely uncoiled from the spool body, the animal experiences an abrupt jerk on its neck, with the leash holder feeling the same jerk on their hand or arm. The abrupt jerk can even cause injury to the animal. To avoid these dangers and also to enable the animal to be stopped before it reaches the end of the uncoiled animal leash, it is known from the prior art to equip retractable leash devices with a brake switch to be operated manually by the leash holder, which mechanically engages in the spool body and blocks further rotation of the spool body and thus further uncoiling of the animal leash. It is also known that a manually operated brake switch brakes the rotation of the spool body to a standstill, whereby the attainment of the standstill and the effect of the braking depend on the force applied to the brake switch by the leash holder. It is not particularly advantageous that the braking effect achieved by means of the brake switch depends solely on the force applied to the brake switch by the leash holder.

The invention is based on the problem of providing a solution which, in a structurally simple and inexpensive manner, provides a simplified, improved and more effective retractable leash device and avoids the disadvantages of known retractable leashes devices.

This problem is solved by a retractable leash device for uncoiling and coiling an animal leash with the features according to patent claim 1.

The retractable leash device according to the invention for uncoiling and coiling an animal leash comprises a housing, a spool body rotatably mounted on the housing, and a return spring, wherein the return spring is designed to push back or hold back the spool body into a coiling position in which the animal leash is coiled onto the spool body, wherein the spool body can be rotated out of the coiling position against a return force of the return spring for uncoiling the coiled animal leash, wherein a brake device is mounted inside the housing, which has a braking element designed to brake the rotating spool body, wherein the brake element is movable against the force of a return element from a rest position, in which the spool body can rotate freely, into a braking position, in which the brake element brakes rotation of the spool body, wherein a remaining length detection device designed to detect a predetermined remaining length of the animal leash coiled onto the spool body is arranged inside the housing, and wherein an automatic braking device coupled to the remaining length detection device is arranged inside the housing, which, when the predetermined residual length of the animal leash coiled onto the spool body is reached, is designed to urge the braking element in the direction of an automatic braking position and to brake the spool body with an automatic braking force.

Advantageous and expedient embodiments and further developments of the invention are apparent from the corresponding subclaims.

The invention provides a retractable leash device which solves the above-mentioned problems in a structurally simple manner. The self-retracting leash device according to the invention has an automatic braking device which is designed in such a way that when the predetermined remaining length of the animal leash is reached, an automatic braking force is automatically generated for the braking element. As a result, the animal first feels the automatic braking force before a “jerk” at the end of the leash, which reduces the “jerk” at the end of the leash if the animal moves further away from the leash holder and reaches the end of the animal leash. Furthermore, the automatic braking force, which is perceptible to the animal, can cause the animal to change its behavior and, for example, slow down or even stop running away, especially if the animal has experienced that, after braking by the automatic braking force, a “jerk” and sudden stop can occur if it continues to move away from the leash holder.

For particularly favorable detection of the remaining length of the animal leash, the invention provides that the remaining length detection device is designed to determine the predetermined remaining length of the animal leash coiled onto the spool body on the basis of a predetermined number of revolutions and/or partial revolutions of the spool body rotating as the animal leash uncoils.

The detection of the remaining length of the animal leash and the initiation of the automatic braking force can be advantageously achieved by the remaining length detection device being designed as a reduction gear and having at least one gear wheel rotatably mounted inside the housing, which is designed to transmit the rotation of the spool body to the automatic braking device continuously and in a reduced ratio. The reduction gear can, for example, be designed as a cascaded spur gear, as a worm gear, as a harmonic wave gear or as a cycloid gear.

An advantageous alternative is also provided in that the remaining length detection device is designed as a step gear and has a step wheel rotatably mounted inside the housing, which is designed to transmit the rotation of the spool body to the automatic braking device intermittently. The step gear, which can also be referred to as a counting gear, can be designed, for example, as a Maltese cross gear (also known as a Geneva gear), as a globoid gear or as an index gear.

The step gear can be designed as a kind of counter for the rotations of the spool body, wherein the invention provides in a further embodiment that the spool body is designed with a driver tooth which engages in the step wheel once per revolution of the spool body and rotates the step wheel by a predetermined step wheel partial revolution.

In a further embodiment of the step gear, the invention provides for ideal detection of the rotation of the spool body in that the remaining length detection device has an index wheel rotatably mounted inside the housing, which is arranged between the step wheel and the automatic braking device and which is designed to be brought into operative connection with the automatic braking device, wherein the step wheel is designed to engage in the index wheel after a predetermined number of predetermined step wheel partial revolutions and to rotate the index wheel by a predetermined index wheel partial revolution.

In the design of the invention, it is particularly advantageous if the automatic braking device has a control element via which the remaining length detection device is movement-coupled to the braking device in such a way that, at the latest when the predetermined remaining length of the animal leash coiled onto the spool body is reached, the remaining length detection device moves the control element from a basic position, in which the control element is designed to hold the braking element in its rest position, into an operating position, in which the control element is designed to arrange the brake element in the automatic brake position and the brake element brakes a rotation of the spool body with the automatic braking force.

For flexible use of the braking device, a further embodiment of the invention provides that the control element is connected to the braking device via a control element spring, wherein the control element spring is designed to hold the braking element in the rest position or to push it into the rest position before the predetermined remaining length of the animal leash coiled onto the spool body is reached. Consequently, the control element holds the brake element in the rest position via the control element spring, whereby manual braking by means of a brake switch against the force of the control element spring is possible at any time, so that the control element spring also has the function of holding the brake switch in its unactuated and unpressed position in the rest state.

Accordingly, in a further embodiment, in order to increase the possible applications of the retractable leash device, the invention provides that a brake switch is movably mounted on the housing and is designed in such a way that manual actuation of the brake switch brakes or blocks the uncoiling of the animal leash.

In a further embodiment of the invention, the brake device is designed such that the brake element brakes the spool body as a result of an additional braking force automatically generated by an animal leash tension caused by the uncoiling of the animal leash, and wherein the brake device has a brake deflection device at which the animal leash is deflected and which is movable mounted on the housing so as to be movable relative to the spool body and which is designed to transmit the animal leash tension to the braking element. The braking device of the retractable leash device according to the invention is therefore designed in such a way that the braking element brakes the spool body as a result of an additional braking force automatically generated by the animal leash tension caused by the uncoiling of the animal leash. In the sense of the invention, “braking” means both blocking the spool body against further uncoiling of the animal leash by friction and slowing down the spool body by friction, thereby slowing down the uncoiling of the animal leash. With the aid of this design, it is possible for the brake element to additionally brake the spool body by means of an additional braking force automatically generated by the animal leash tension caused by the rolling of the animal leash before the end of the animal leash is reached. In this way, an automatic braking function is provided, namely when the rope tension or animal leash tension is so high due to the animal running away from the retractable leash device that the braking device automatically brakes or slows down the rotation of the spool body. Since the animal leash tension contributes to the automatic braking force via the brake deflection device, the additional braking force can be varied by the leash holder or user of the retractable leash device holds the animal leash in relation to the housing and thus the brake deflection device in such a way that less, no or more force is transmitted to the brake element via the deflection of the animal leash.

Finally, in the embodiment of the invention, it is a design advantage if the brake device has a brake lever designed as a single-sided lever, which is mounted on a pivot axis on the housing and to which the brake element and the brake deflection device are attached.

It is understood that the features mentioned above and those to be explained below can be used not only in the combination specified in each case, but also in other combinations or alone without leaving the scope of the present invention. The scope of the invention is defined only by the claims.

Further details, features, and advantages of the subject matter of the invention will become apparent from the following description in conjunction with the drawings, in which an exemplary preferred embodiment of the invention is illustrated.

### THE DRAWING SHOWS

FIG. 1 a perspective view of a retractable leash device according to the invention,

FIG. 2 shows the retractable leash device from FIG. 1 in another perspective view and with a housing part hidden,

FIG. 3 shows the retractable leash device from FIG. 1 in another perspective view and with the housing hidden,

FIG. 4 shows a perspective view of a remaining length detection device of the retractable leash device,

FIG. 5 shows a further perspective view of the remaining length detection device of the retractable leash device,

FIG. 6 shows a side view of the retractable leash device, wherein a control element is arranged in a basic position, and

FIG. 7 shows a side view of the retractable leash device, wherein the control element is arranged in an operating position.

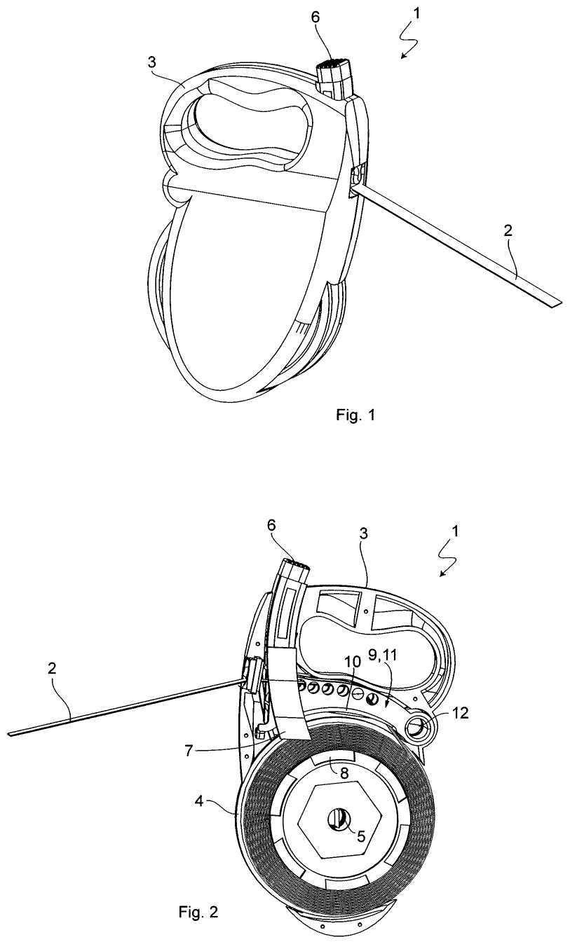

FIGS. 1 and 2 show a retractable leash device 1 according to the invention in different perspective views. The retractable leash device 1 for uncoiling and coiling an animal leash 2 comprises a housing 3 and a spool body 4. The housing 3 is designed in multiple parts, wherein in FIG. 2 one part of the housing 3 is hidden so that the spool body 4 and a return spring 5 can be seen. The spool body 4 is rotatably mounted on the housing 3 and is arranged in FIGS. 1 and 2 in a coiling position in which the animal leash 2 is coiled onto the spool body 4. The return spring 5 is designed to push the spool body 4 back into the coiling position or to hold it there. The spool body 4 is mounted on the housing 3 so that it can rotate out of the coiling position against the return force of the return spring 5 to allow the coiled animal leash 2 to uncoil. Furthermore, a brake switch 6 is provided, which is movably mounted on the housing 3 and can be actuated by an animal leash holder for manually braking the uncoiling animal leash 2. With the aid of the brake switch 6, rotation of the spool body 4 can be blocked if the brake switch 6 is pressed far enough inwards into the housing 3 from the animal leash holder, because then a blocking lug 7 is brought into engagement with a recess 8 formed on the spool body 4. However, the brake switch 6 can also interact with a brake device 9 so that when the brake switch 6 is pressed in less, the animal leash holder merely brakes the spool body 4 instead of blocking it. Interaction between the brake switch 6 and the brake device 9 is only an optional alternative for the invention and is not essential for the invention.

As can be seen in FIG. 2, the brake device 9 is mounted inside the housing 3 and has a brake element 10 designed to brake the rotating spool body 4 when the animal leash 2 unrolls/uncoils. The brake element 10 is designed as a brake shoe which can be brought into contact with a brake surface of the spool body 4 in order to brake the rotating spool body 4. The brake surface can be designed as a section of a peripheral wall of the spool body 4.

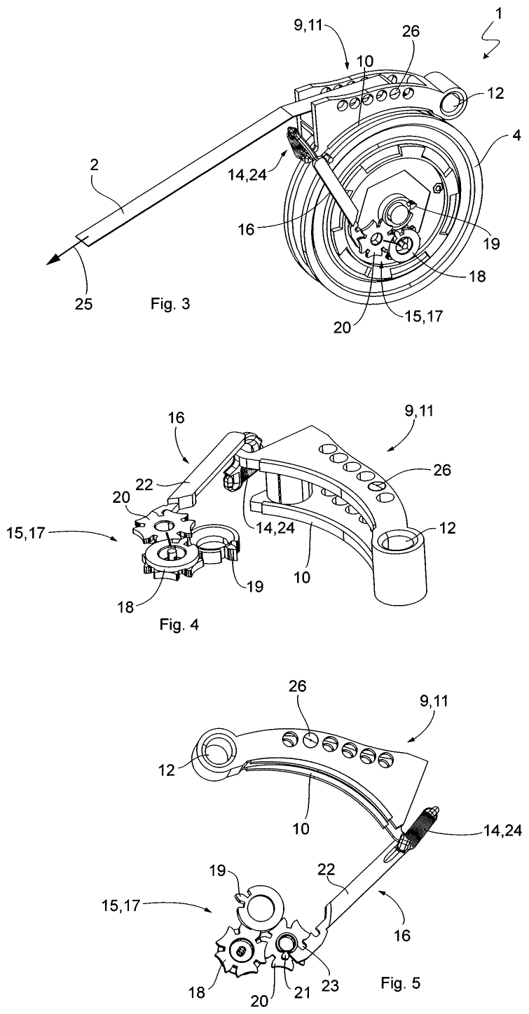

FIG. 3 shows the retractable leash device 1 according to the invention in a further perspective view, but with the housing 3 omitted in order to better show the structure of the retractable leash device 1. With reference to FIG. 3, it can be seen that the brake device 9 is designed as a brake lever 11 mounted on one side, which is mounted on the housing 3 on a pivot axis 12 and to which the brake element 10 is attached. The brake element 10 is movable against the force of a return element 14 from a rest position, in which the spool body 4 can rotate freely, into a braking position, in which the brake element 10 brakes the rotation of the spool body 4. According to the invention, a remaining length detection device 15 is arranged inside the housing 3 for determining a predetermined remaining length of the animal leash 2 wound/coiled onto the spool body 4. Furthermore, according to the invention, an automatic braking device 16 coupled to the remaining length detection device 15 is arranged inside the housing 3, which, when the predetermined remaining length of the animal leash 2 coiled onto the spool body 4 is reached, is designed to push the brake element 10 in the direction of an automatic braking position and to brake the spool body 4 with an automatic braking force.

With the aid of the remaining length detection device 15, the retractable leash device 1 according to the invention is able to detect a predetermined remaining length of the animal leash 2 when the animal leash 2 is unwinding/uncoiling. For this purpose, the remaining leash detection device 15 is designed to determine the predetermined remaining length of the animal leash 2 wound/coiled onto the spool body 4 on the basis of a predetermined number of revolutions and/or partial revolutions of the spool body 4 rotating when the animal leash 2 is unwound/uncoiled. The remaining length detection device 15 can be designed as a reduction gear, so that the remaining length detection device 15 has at least one gear wheel rotatably mounted inside the housing 3, which is designed to transmit the rotation of the spool body 4 to the automatic braking device 16 continuously and in a reduced ratio. In the embodiment shown in the figures, the remaining length detection device 15 is designed as a step gear 17. As can be seen from FIGS. 3 to 5, the remaining length detection device 15 has a step wheel 18 rotatably mounted inside the housing 3, which is designed to transmit the rotation of the spool body 4 to the automatic braking device 16 intermittently. For this purpose, the spool body 4 is designed with a driver tooth 19 which engages in the step wheel 18 once per revolution of the spool body 4 and rotates the step wheel 18 by a predetermined step wheel partial revolution. Consequently, for each revolution of the spool body 4, the driver tooth 19 engages in the step wheel 18 so that the step wheel 18 is rotated by a step wheel partial revolution of, for example, 72°, and after five revolutions of the spool body 4, the step wheel 18 has performed a complete revolution. As can also be seen in FIGS. 3 to 5, the remaining length detection device 15 has an index wheel 20 mounted rotatably within the housing 3. The index wheel 20 is arranged between the step wheel 18 and the automatic braking device 16 and is designed to be brought into operative connection with the automatic braking device 16. The step wheel 18 is further designed such that, after a predetermined number of predetermined step wheel partial revolutions, the step wheel 18 engages in the index wheel 20 and rotates the index wheel 20 by a predetermined index wheel partial revolution. For example, after five partial revolutions of the step wheel 18, the index wheel 20 rotates by an index wheel partial revolution of, for example, 72°, wherein the index wheel 20 interacts with the automatic braking device 16 after five index wheel partial revolutions. For the example, this means that after a total of twenty-five rotations of the spool body 4, the index wheel 20 interacts with the automatic brake device 16. The remaining length detection device 15 is thus designed in the embodiment shown as a three-stage step gear, wherein the step wheel 18 is designed with a first stage, which interacts with the driver tooth 19 of the spool body 4, and a second stage, which interacts with the index wheel 20. The index wheel 20 is also designed with a first stage, which interacts with the step wheel 18, and a second stage, which interacts with the automatic brake device 16. The second stage of the index wheel 20 has an actuating tooth 21 which engages with the automatic brake device 16 when the index wheel 20 has performed a predetermined number of predetermined index wheel partial revolutions. Of course, other designs of the remaining length detection device 15 than those described above are also conceivable. It is essential for the invention that the number of rotations of the spool body 4 is transmitted via a gear to the automatic braking device 16 in such a way that after a predetermined number of rotations of the spool body 4, which defines the predetermined remaining length of the animal leash 2, the automatic braking device 16 pushes the braking element 10 in the direction of the spool body 4 and brakes the spool body 4 with an automatic braking force.

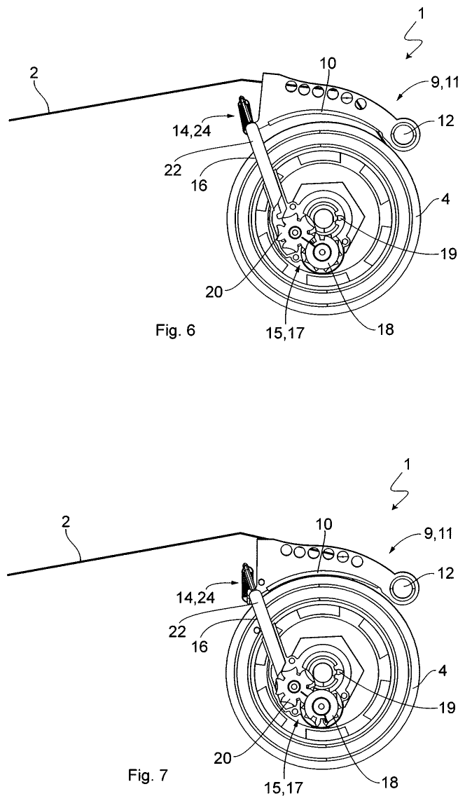

For the interaction of the remaining length detection device 15 and the automatic braking device 16, in the embodiment shown, the automatic braking device 16 is equipped with a control element 22. The control element 22 is designed in the manner of a coupling rod and is mounted within the housing 3 in a manner that allows it to move. The remaining length detection device 15 is connected to the brake device 9 via the control element 22 in such a way that when the predetermined remaining length of the animal leash 2 coiled onto the spool body 4 is reached, the remaining length detection device 15 moves the control element 22 from a rest position into an operating position. In the rest position, the control element 22 is designed to hold the brake element 10 in its rest position, as shown in FIG. 6. FIG. 7 shows the operating position in which the control element 22 is designed to arrange the brake element 10 in the automatic braking position and the brake element 10 brakes a rotation of the spool body 4 with the automatic braking force. In the embodiment shown, the displacement of the control element 22 from the basic position to the operating position then takes place when the index wheel 20 has performed the specified number of specified index wheel partial rotations, wherein, in order to move the actuating tooth 21 into a control recess 23 of the control element 22, it engages with the control element 22 and pulls the control element 22 toward itself, thereby moving the brake element 10 in the direction of the spool body 4. As can be seen from the combined view of FIGS. 3 to 7, the control element 22 is connected to the brake device 9 via a control element spring 24. The control element spring 24 is designed to hold the brake element 10 in the rest position or to push it into the rest position before the animal leash 2 reaches the predetermined residual length coiled on the spool body 4. Furthermore, the control element spring 24 is designed as the return element 14. In other words, the control element 22 is connected to the brake device 9 via the return element 14. The return element 14 or the control element spring 24 is therefore designed in such a way to hold the brake element 10 in the rest position or to push it back into the rest position when the animal leash 2 is rolled off, so that the rolled-off/uncoiled animal leash 2 can be rolled up/coiled when the animal leash tension 25 caused by the rolling off of the animal leash 2 decreases or is no longer present. On the other hand, the return element 14 or the control element spring 24 is designed to hold the brake switch 6 in its initial position when not actuated, whereby the brake switch 6 can be manually actuated by the animal lead guide against the force of the return element 14 or against the force of the control element spring 24, so that the brake element 10 brakes the spool body 4.

Finally, in the retractable leash device 1 according to the invention, the brake device 9 can be designed such that the brake element 10 brakes the spool body 4 as a result of the additional braking force automatically generated by the animal leash tension 25 caused by the unwinding/uncoiling of the animal leash 2, as illustrated in FIG. 3. For this purpose, the brake device 9 has a brake deflection device 26 (see FIG. 3) on which the animal leash 2 is deflected and which is mounted on the housing 3 so as to be movable relative to the spool body 4 and which is designed to transmit the animal leash tension 25 to the brake element 10. The brake deflection device 26 is designed in the manner of a deflection roller and is attached to the brake lever 11 at a distance from the pivot axis 12. With the aid of the brake deflection device 26, the brake element 10 can automatically brake the spool body 4 as a result of the automatically generated additional braking force, which is generated by the animal leash tension 25 when the animal leash 2 is rolled off, even before the residual length of the animal leash 2 is reached. If, when the residual length of the animal leash 2 is reached, the animal leash tension 25 and thus the generated additional braking force are greater than the automatic braking force, then the additional braking force acts as a braking force amplifier and increases the braking effect of the braking element 10.

The invention described above is, of course, not limited to the embodiment described and illustrated. It is apparent that numerous modifications can be made to the embodiment shown in the drawings which are obvious to a person skilled in the art in accordance with the intended application without leaving the scope of the invention. The invention includes everything contained in the description and/or shown in the drawings, including anything that is obvious to a person skilled in the art and deviates from the specific embodiment.

### LIST OF REFERENCE SIGNS

1 Retractable leash
2 Animal leash
3 Housing
4 Spool body
5 Return spring
6 Brake switch
7 Blocking attachment
8 Recess
9 Brake device
10 Brake element
11 Brake lever
12 Pivot axis
14 Return element
15 Remaining length detection device
16 Automatic braking device
17 Step gear
18 Step wheel
19 Driver tooth
20 Index wheel
21 Actuating tooth
22 Control element
23 Control recess
24 Control element spring
25 Animal leash tension
26 Brake deflection device

1. A retractable leash device for uncoiling and coiling an animal leash, wherein the retractable leash device comprises a housing, a spool body rotatably mounted on the housing, and a return spring which returns the spool body to a coiling position in which the animal leash is arranged coiled on the spool body, wherein the spool body can be rotated out of the coiling position against a return force of the return spring for uncoiling the coiled animal leash,
wherein a brake device is mounted inside the housing, which brake device has a brake element designed to brake the rotating spool body, wherein the brake element is movable against the force of a return element from a rest position, in which the spool body can rotate freely, into a braking position, in which the brake element brakes the rotation of the spool body, wherein a remaining length detection device designed to detect a predetermined remaining length of the animal leash coiled on the spool body is arranged inside the housing, and
wherein an automatic braking device coupled to the remaining length detection device is arranged inside the housing, which, when the predetermined remaining length of the animal leash coiled onto the spool body is reached, is designed to urge the braking element in the direction of an automatic braking position and to brake the spool body with an automatic braking force.

2. A retractable leash device according to claim 1, wherein the remaining length detection device is designed to determine the predetermined remaining length of the animal leash coiled onto the spool body on the basis of a predetermined number of revolutions and/or partial revolutions of the spool body rotating during uncoiling of the animal leash.

3. A retractable leash device according to claim 1, wherein the remaining length detection device is designed as a reduction gear and comprises at least one gear wheel rotatably mounted inside the housing, which is designed to transmit the rotation of the spool body to the automatic braking device continuously and in a reduced ratio.

4. A retractable leash device according to claim 1, wherein the remaining length detection device is designed as a step gear and has a step wheel rotatably mounted inside the housing, which is designed to intermittently transmit the rotation of the spool body to the automatic braking device.

5. A retractable leash device according to claim 4, wherein the spool body is designed with at least one driver tooth which engages in the step wheel per one revolution of the spool body and rotates the step wheel by a predetermined step wheel partial revolution.

6. A retractable leash device according to claim 5, wherein the remaining length detection device has an index wheel rotatably mounted inside the housing, which is arranged between the step wheel and the automatic braking device and which is designed to be brought into operative connection with the automatic braking device, wherein the step wheel is designed to engage in the index wheel after a predetermined number of predetermined step wheel partial rotations and to rotate the index wheel by a predetermined index wheel partial rotation.

7. A retractable leash device according to claim 1, wherein the automatic braking device has a control element via which the remaining length detection device is movement-coupled to the braking device in such a way that the remaining length detection device moves the control element from a basic position, in which the control element is designed to hold the brake element in its rest position, into an operating position at the latest when the predetermined remaining length of the animal leash coiled onto the spool body is reached, wherein in the operating position the control element is designed to arrange the brake element in the automatic braking position and the brake element brakes a rotation of the spool body with the automatic braking force.

8. A retractable leash device according to claim 7, wherein the control element is connected to the brake device via a control element spring, wherein the control element spring is designed to hold the brake element in the rest position or to push it into the rest position before the predetermined remaining length of the animal leash coiled onto the spool body is reached.

9. A retractable leash device according to claim 1, wherein a brake switch is movably mounted on the housing and is designed such that, as a result of manual actuation of the brake switch, the uncoiling of the animal leash is braked or blocked.

10. A retractable leash device according to claim 1, wherein the brake device is designed such that the brake element brakes the spool body as a result of an additional braking force automatically generated by an animal leash tension caused by the uncoiling of the animal leash, and wherein the braking device has a brake deflection device at which the animal leash is deflected and which is movable mounted on the housing so as to be movable relative to the spool body and which is designed to transmit the animal leash tension to the brake element.

11. A retractable leash device according to claim 10, wherein the brake device comprises a brake lever designed as a single-sided lever, which is mounted on a pivot axis on the housing and to which the brake element and the brake deflection device are attached.
